(19) United States
(12) Patent Application Publication
(10) Pub. No.: US 2008/0004377 A1
(43) Pub. Date: Jan. 3, 2008

(54) Product useful with a squirt device and methods for its preparation

(76) Inventors: Johan Claes Wilhelm Axelsson, Stockholm (SE); Fredrik Robin Lechard Lilieblad, Stockholm (SE); Anders Gustaf Wretling, Stockholm (SE); Carl Johan Udo Bieneck, Stockholm (SE)

Correspondence Address: Anders Wretling, Regeringsgatan 97, Stockholm, 11139, SE

(21) Appl. No.: 11/820,188

(22) Filed: Jun. 19, 2007

Related U.S. Application Data
(60) Provisional application No. 60/815,780, filed on Jun. 22, 2006.

(51) Int. Cl. C08L 1/10; C08L 5/00; C08L 5/02

(52) U.S. Cl. 524/37; 524/54; 524/55

(57) ABSTRACT

The present invention relates to a product comprising a preparation for mixture with a solvent to form a squirtable polymer solution for use in squirt devices. The preparation comprises a polymer thickening agent in combination with a mixing material. The thickening agent and mixing material are selected and formulated so that said product retains its homogeneity during storage of at least 1 week and that the mixing material is selected and formulated so that the preparation does not form lumps dissolved in a solvent. The invention further comprises methods to obtain suitable such preparation and a method of loading a squirt device with the product.

### CROSS REFERENCE TO RELATED APPLICATION

This application is derived from provisional application U.S. 60/815,780, “A product useful with a squirt device and methods for its preparation” filed on Jun. 22, 2006.

### FIELD OF INVENTION

The present invention relates to products comprising preparations suitable for admixture with a solvent to form a polymer solution that can be squirted with a squirt device (e.g. water gun), and methods to develop and obtain such preparations and products.

### BACKGROUND OF THE INVENTION

Polymer solutions having Theological properties characterized by a shear thinning behavior are well known in numerous technical applications. During squirting, the viscosity diminishes under shearing, while after the cessation of shearing, an adhering thick polymer solution resets on a target surface.

The German Patent Specification DE 100 56 959 describes such polymer solutions to be used with conventional water guns for amusement. The polymer solution can be made to have a thick slimy consistency and be colored which could make it a fun alternative compared to squirting ordinary water. A specific formulation based on activated Carbopol that forms a polymer solution with a low shear viscosity is suggested. However the suggested preparation is made as a two component system (with an activator) and to prepare the polymer solution by mixture with water it requires a certain level of operational skill, a two step process, equipment and agitation during incorporation of the ingredients. Further on the two component system has quite a large volume in relation to the water that it should be mixed with. These polymer solutions are also readied outside the squirt device in large bulk quantities and it may be inconvenient or cumbersome to transfer them to the reservoir of a water gun. Further on Carbopol is quite expensive compared to other thickening agents. As an alternative to Carbopol the thickening agent xanthan is mentioned but it is said that more of the xanthan is needed to achieve the same results, as with Carbopol.

In the above mentioned German Specification, it is suggested as an alternative formulation to use succinoglycan gum, which would not need an activator to obtain the desired polymer solution. However it is said that this gum does not dissolve so easily in water and that a special procedure therefore is needed. The succinoglycan gum should be premixed with the same amount of ethanol and then under intensive agitation put into the water. However, our tests have shown that if you first put the succinoglycan gum and ethanol preparation into the water and then start the agitation the preparation will be difficult to dissolve with a high risk for lumping. Therefore, also with this preparation agitation during incorporation of the ingredients is needed. Further on, the preparation starts layering shortly after it has been prepared (within a few minutes) resulting in a bottom layer mainly consisting of succinoglycan gum and a top layer mainly consisting of ethanol. The more the preparation layers the harder it will be to dissolve the preparation in water without formation of lumps. Lumps make the polymer solution uneven, less viscous and the lumps may clog the tubes in the water gun, damaging the water gun. Further on if the preparation would be packaged in for example a bottle, tube or pouch it would be very difficult for a consumer to make the preparation homogeneous again and to dispense the preparation since the bottom layer gets very hard within a week. Therefore such preparation is not suitable for a product that requires some shelf life and also not for a product that should be prepared without agitation during incorporation of the ingredients. Similar results are achieved when using the suggested alternatives for ethanol in combination with succinoglycan gum.

Additionally, to use Carbopol, xanthan or succinoglycan gum as thickening agent is not so attractive for this type of consumer product because of a relatively high price. Further on Carbopol and succinoglycan gum are not food grade which could be a disadvantage since the polymer solution might hit the mouth of a person and be accidentally ingested during games (e.g. persons squirting polymer solution at each other). For the same reason it might not be so good to use ethanol as pre mixing agent for succinoglycan gum since a big target group for these games is likely to be children.

Another type of squirtable gelling composition is described in U.S. Pat. No. 5,549,933 (Adams et al). In this patent it is suggested to use a composition that gels in contact with a cold surface, which puts a limit on the applicability.

It is evident that if a preparation should be sold to consumers as a concentrate to be mixed with water to form a polymer solution for use with conventional squirt devices (e.g. water guns) for amusement or for other ambulatory purposes a number of problems need to be solved before an easy handled system is obtainable. For example, a product should easily form a polymer solution without any other equipment than the squirt device (e.g. water gun), a product should preferably not be made as a two component system requiring a two step process to prepare the polymer solution, it should not be needed to have agitation whilst the product is put together with the water, a product should be small and easy to carry, a product should have an acceptable shelf life, and a product should be delivered to the consumers in a package that allows for convenient dispensing. Further on, a product should be easy to manufacture from inexpensive raw materials, while it should be non-toxic, nonirritating, environmentally acceptable and preferably food grade. The present invention aims at providing a product that meets these mentioned requirements.

### DESCRIPTION OF THE INVENTION

It is a general objective of the present invention to provide a product in the form of a concentrate (preparation) with an acceptable shelf life that in a simple and convenient manner can be mixed with a solvent to prepare a polymer solution that can be squirted with a squirt device.

It is another object of the present invention to provide a product that is convenient and easy to bring along and use ambulatory to provide a squirtable polymer solution.

In general terms the present invention relates to a product with an acceptable shelf life comprising a preparation for mixture with a solvent to form a squirtable polymer solution for use with squirt devices without need for any additional or complementary equipment to prepare the polymer solution in a repeatable and satisfying manner. The preparation comprises a thickening agent in combination with a mixing material that can be packaged in a package enabling convenient displacement of the preparation to the reservoir of a squirt device. The thickening agent and the mixing material are selected and formulated so that said product retains its homogeneity during storage of at least 1 week and that the mixing material is selected and formulated so that the preparation after at least 1 week storage has a lower tendency for lumping when dissolved in a solvent compared to dissolving in the same solvent a preparation without said mixing material, but comprising the same amount of thickening agent. In this context, an acceptable shelf life is defined as at least one month. The thickening agent generally is a soluble polymer material, that in solution in a solvent provides higher viscosity of the solution, than the viscosity of the solvent itself. The mixing material is a material that minimizes the risk for lumping when the preparation is mixed with a solvent. The solvent preferably is water or water based, however, other polar liquids are generally conceivable to use with the present invention. A squirt device is defined as a product with which it is possible to squirt, shoot or spray a liquid material. Examples are water guns (e.g. air pressure water guns), squirt guns, spray devices, etc. The skilled person can readily implement the present invention as described here, and in the following, with various types of such devices.

Suitably, the mixing material is soluble in the solvent, or capable of forming a homogenous mixture or emulsion with the solvent by contribution of the thickening agent, or if necessary by the contribution of an additional agent in the preparation. Such an additional agent can be an emulsifier with capacity of forming a homogenous emulsion from the system of thickening agent, mixing material and the solvent, or an other agent which can contribute to generate a homogenous system, for example by crosslinking the polymer chains of the thickening agent to a homogenous network. In this context, it is also contemplated that purposefully selected systems of thickening agent, mixing material and the solvent can form emulsions or homogenous dispersions without employment of additional agents.

According to one aspect of the invention, the product comprises a mixing material that is a liquid. Further to this aspect, the thickening agent and the mixing material are selected so that the preparation retains a homogeneous appearance after 1 week storage, when prepared in a weight ratio of thickening agent:mixing material of 1:1, but that gets a layered appearance after 1 week storage when prepared at a weight ratio of 1:15. More preferably, the thickening agent and the mixing material are selected so the preparation retains a homogeneous appearance after 1 week storage, when prepared in a weight ratio of thickening agent:mixing material of 1:1.4, but that gets a layered appearance after 1 week storage when prepared at a weight ratio of 1:10. Even more preferably, the thickening agent and the mixing material are selected so that the preparation retains a homogeneous appearance after 1 week storage, when prepared in a weight ratio of thickening agent:mixing material of 1:1.7, but that gets a layered appearance after 1 week storage when prepared at a weight ratio of 1:7.5.

According to another aspect of the invention the mixing material is semisolid. Irrespectively of that the mixing material is liquid or semisolid, it is preferable that it provides the preparation with a density above 1, preferably above 1.075 and more preferably above 1.15 (kg/dm³), while it is preferably that the product comprises thickening agent and mixing material in a weight ratio range of thickening agent:mixing material from 1:1 to 1:15, preferably in the range of 1:1.4 to 1:10, and more preferably in the range of 1:1.7 to 1:7.5. Especially preferred liquid mixing materials in the mentioned preparations are glycerin or propylene glycol, while it is suitable that the mentioned preparations have a viscosity that is less than 500000 Pa-s, preferably less than 50000 Pa-s, and more preferably less than 5000 Pa-s (when measured at 25 degrees C. and 10 rad/s).

In accordance with a special embodiment of the invention, the product comprises a solid preparation to be dissolved with a solvent to a squirtable solution in a squirt device under conditions as mentioned in the foregoing sections. For this purpose, the mixing material suitably is a dry powder or grains, and the mixing material preferably is cold water soluble. In order to avoid insufficiently homogenous products, it is suitable that the material with the highest particle density of the mixing material and the thickening agent do not deviate in particle density more than 500%, preferably not more than 100% and more preferably not more than 50%, from the material with the lower particle density of the mixing material and the thickening agent. For the same reason, it is suitable that the difference in average particle size in microns (for example measured with Tyler Standard Screen Scale Sieve Series) between the thickening agent and the mixing material is less than 50000%, preferably 7500%, and more preferably less than 500%. According to one aspect, the powder or grains of the mixing material is pressed together with the thickening agent to form a tablet. According to another aspect, the thickening agent and mixing material has been mixed and agglomerated into a powder or grain, for the purpose of making each particle contain both mixing material and thickening agent. To assist with the dissolution of the product in the solvent, the preparation (both solid and liquid) may comprise one or several effervescent agent(s) that allows for disintegration of the preparation when it is put into the solvent. The person skilled in formulation technology can easily identify suitable effervescent agents for the present invention and such agents will not be discussed in further detail. In the discussed embodiment, a water solution of the mixing material suitably has a viscosity (at 25 degrees C.) that is less than 30%, preferably less than 10% and more preferably less than 5% of the viscosity of a water solution with same amount (weight) of thickening agent, while the mixing material suitable is present in the preparation in a weight in the preparation that is material is at least 10%, preferably at least 80%, and more preferably at least 150% of the weight of the thickening agent. Furthermore a dry thickening agent suitable has a particle size, corresponding to a mesh number of 50, or higher, preferably, a mesh number of 100, or higher, or more preferably a mesh number of 150, or higher (as measured with e.g. Tyler Standard Screen Scale Sieve Series). Suitable solid mixing materials are cold water soluble and selected from the group consisting of sugars, sugar alcohols, oligosaccharides, polysaccharides and any mixture thereof.

In any of the previously described embodiments or aspects of the invention, it is preferable that the product accordingly comprises a thickening agent that is capable of forming a shear thinning solution after being mixed with the solvent. The terms shear thinning means that a solution of the selected thickening agent has a lower viscosity under shearing conditions and a higher viscosity at rest, e.g. when a squirted solution of the polymer thickening agent has reached a target. Suitably, according to the invention, a 1% (weight) water solution of thickening agent has a viscosity of at least 500 Cps, preferably at least 1 000 Cps, more preferably at least 2000 Cps after 24 hours (Brookfield RVT Viscometer 25° C., Spindle No. 3 or 4, 20 rpm). In order to provide for an ambulatory product that is easy to bring along and handle, the product suitably comprises a preparation comprising thickening agent in an amount of 0.05-15%, preferably 0.15-8%, more preferably 0.3-3%, in relation to the weight of the solvent to be mixed with. A suitable thickening agent is selected from the group consisting of guar gum, tara gum, carrageenan, carboxymethylcellulose (CMC), xanthan gum, alginate, dextran, hydroxyethylcellulose (HEC) and hydroxypropylcellulose, or mixtures thereof. Especially suitable thickening agents are tara gum or guar gum. Further in any mentioned embodiment or aspect, the preparation may comprise a color, a preservative, a buffering agent, a flavor or a fragrance, or a combination of these.

In presently most preferred products, the preparation comprises guar gum as a thickening agent, glycerin as a mixing material, which when dissolved with water to a 1% (weight) solution of guar has a viscosity of at least 2500 Cps after 24 hours (Brookfield RVT Viscometer 25° C., Spindle No. 3 or 4, 20 rpm).

A product according to the present invention can further comprise a storage package capable of accommodating the preparation. A storage package in the context of the present invention generally is adapted to hold and protect the preparation during storage and is designed to allow convenient access to the preparation, for example by dispensing, when it shall be used together with a solvent to prepare the squirtable solution. The package preferably is adapted so that the preparation is squeezed or pressed out when emptying said package, while it preferably has an opening which when the preparation is squeezed or pressed out of the package is between 1-1500 square mm, preferably between 5-700 square mm and more preferably between 10-320 square mm. The material of the package can at least partially be made from a material that is soluble in said solvent. Such materials are well-known to skilled practitioners and will not be further discussed herein.

The present invention can also be a kit comprising a product identified in any previous section and at least one squirt device.

The present invention also provides for a method including employing a product identified in any previous section; and admixing the product with a solvent into the final squirtable solution. The method is performed without inconvenient complementary measures and is intended to be simple and user friendly. Preferably, the method includes dispensing the preparation from a package identified in previous section, and suitably the preparation and the solvent can be dispensed into the reservoir of a squirt device in any order convenient for the user. The admixing preferably is made by manually and simply shaking the reservoir of the squirt device, which provides a simple readying process of the squirtable solution without any need to agitate or stir the solvent when bringing the preparation and the solvent together.

The present invention further relates to methods of providing storage stable products especially suitable for ambulatory forming a squirtable polymer solution that can be used in squirt devices following mixture with an operating solvent which are storage stable and easily without complications form the ready to use solution.

According to a first embodiment the methods comprises a first step of selecting a polymer thickening agent capable of providing squirtable viscous polymer solutions, selecting mixing material that is liquid; and providing preparations of thickening agent and mixing material with different weight ratios of thickening agent and mixing material; a second step of selecting the preparations of the first step which retain a homogenous appearance after at least 1 hour, preferably at least 1 day and more preferably at least 1 week storage; and a third step of selecting preparations obtained in the second step, which are easily dissolved in water with manual agitation; and thereafter selecting such preparations for manufacturing a storage stable product.

Alternatively, according to another embodiment, the present invention comprises methods and products obtained from such methods, wherein the methods comprise a first step of selecting a polymer thickening agent capable of providing squirtable viscous polymer solutions, selecting a mixing material that is liquid; and providing preparations of thickening agent and mixing material with different weight ratios of thickening agent and mixing material; a second step of selecting preparations provided in the first step that easily can be dissolved in water with manual agitation to a squirtable polymer solution without formation of lumps; a third step of selecting the preparations obtained from the second step which retain a homogenous appearance after at least 1 hour, preferably at least 1 day and more preferably at least 1 week storage; and further a fourth step of verifying if the preparations obtained in the third step are easily dissolved in water using manual agitation and selecting such preparations for manufacturing a storage stable product.

The methods will preferably generate products comprising a preparation which when dissolved into a water solution containing 2% (weight) of the preparation has a viscosity of at least 1000 Cps after 24 hours (Brookfield RTV Viscometer, 25° C., Spindle No. 3 or 4, 20 rpm).

In one embodiment, the method comprises providing preparations of thickening agent:mixing material in the first step in a weight ratio range from 1:1 to 1:15, whereby a preparation retains a homogenous appearance at a proportion of 1:1, but gets a layered appearance at a proportion of 1:15 following storage during 1 week.

In another embodiment, the method comprises providing preparations of thickening agent:mixing material in the first step in a weight ratio range from 1:1.4 to 1:10, whereby a preparation retains a homogenous appearance at a proportion of 1:1.4, but gets a layered appearance at a proportion of 1:10 following storage during 1 week.

In yet another embodiment, the method comprises providing preparations of thickening agent:mixing material in the first step in a weight ratio range from 1:1.7 to 1:7.5, whereby a preparation retains a homogenous appearance at a proportion of 1:1.7, but gets a layered appearance at a proportion of 1:7.5 following storage during 1 week.

In the following detailed and exemplifying part of the specification, a number of prerequisites of the invention are discussed and illustrated which shall not be regarded as limiting for its scope, which is set out in the appended claims.

### DETAILED AND EXEMPLIFYING PART OF THE DESCRIPTION

The thickening should advantageously have shear thinning properties since a longer squirting range is obtained. This because the polymer solution gets a lower viscosity when it is squirted which reduces the force needed to squirt the polymer solution, compared to a polymer solution with the same viscosity at rest but that is not shear thinning. The thickening agent should be cold water soluble since this makes it possible for the user to conveniently mix the preparation with ordinary tap water without any need for heating to form the resulting polymer solution. For the sake of convenience, it is important that the preparation dissolves quickly in the solvent and that the resulting polymer solution rapidly reaches a satisfactory viscosity. The present inventors have found that for ordinary non pre-hydrated thickening agents, a lower particle size of the thickening agent normally decreases the time until the polymer solution reaches a certain viscosity (ceteris paribus). The particle size can be measured in mesh; a higher mesh number means a smaller particle size. Suitably, the mesh number should be more than 50, preferably it should be more than 100 and more preferably it should be more than 150. A lower mesh number is also conceivable, but it makes the product less user friendly, since the user will have to wait until a satisfactory viscosity has been reached.

The thickening agent should also be powerful so that only a small amount is needed to create a polymer solution with a suitable viscosity. This aspect is important since the amount of the thickening agent needed affects the volume of the product. Especially since the amount of mixing material needed is related to the amount of the thickening agent. Since the product should be carried by the user, for example in the pocket and since the user should be able to easily carry enough of the product to be able to make several liters of the polymer solution it is important that the product is not too voluminous. Suitably a preparation containing a thickening agent, mixing material and additives (if needed), adapted to be dissolved in 1 liter of water should not weight more than 150 gram. Preferably it should weight less than 120 gram and more preferably it should weight less than 75 gram . . . The present inventors have experienced that when dissolving a thickening agent in the form of powder or grains in water, there is a high risk for lumping. Lumps occur since the thickening agent particles that first get in contact with the solvent quickly dissolves and forms a wall of high viscous polymer solution around the other thickening agent particles (a lump). This hinders the thickening agent particles inside the lump to get access to the solvent and therefore it will take long time until the thickening agent particles inside the lump dissolves. Lumps make the polymer solution uneven and they may also clog the tubes in the squirt device and it is therefore important to be able to dissolve the thickening agent without lumps. Normally this problem can be handled if the solvent is stirred vigorously whilst the thickening agent is slowly sprinkled into the solvent. However for the sake of best product convenience no stirring equipment should be needed by the user and the polymer solution should not need to be sheared whilst the thickening agent is put into the solvent. It should accordingly be possible for the user to put the preparation containing the thickening agent into the solvent filled reservoir of the squirt device (e.g. water gun) and then afterwards just manually shake the squirt device until the thickening agent has dissolved and formed the polymer solution. Preferably it should also be possible to wait for a short time (e.g. 30 seconds) after the preparation has been put together with the solvent before the shaking starts. This since it always takes some time to empty the package and put the lid back on to the reservoir of the squirt device before the shaking can start.

The present inventors have realized that it is important that the thickening agent is mixed with a sufficient amount of a mixing material in order to perform a adequate mixing that meets all mentioned requirements. For particulate thickening agents, the particles need to be separated before being put into the solvent so they obtain a uniform access to the solvent. The mixing material is used in the preparation to perform such a separation and generally, the more mixing material included in the preparation, the easier it will be to dissolve the preparation in the solvent, but the preparation will then become more expensive and voluminous.

When the mixing material is liquid, many combinations of liquids and thickening agents that will dissolve easily in the solvent can be contemplated. However, if an acceptable shelf life is considered only certain combinations are suitable. Many combinations containing a sufficient amount of liquid mixing material are adequate shortly after the preparation is made, but will layer into two or more layers after a short time storage (within a week), so that the preparation gets a layered appearance (non-homogeneous appearance) which can be seen as two or more layers with different color or transparency if looking at the preparation from the side through a transparent beaker. Usually it is two layers and usually the bottom layer mainly contains the thickening agent and the top layer mainly contains the liquid mixing material. Liquid mixing material that is separated from the thickening agent will not contribute to reduce the risk for lumping and the preparation will therefore be hard to dissolve without lumping when using manual agitation. Furthermore the bottom layer usually gets very hard making the preparation difficult to dispense and making it hard for the consumer to make the layered preparation homogenous again. An example of a preparation that works well in the beginning but that gets a layered appearance within a week is the combination of guar gum 5000 cps 300 mesh and ethanol in a relation of 1:2. After a week the bottom layer is equivalent to a mixture of 1:0.8 (guar gum:ethanol), which results in an insufficient amount of liquid mixing material remains homogenously mixed with the thickening agent. If glycerin instead is used as a liquid mixing material in a proportion of 1:2 (guar gum:glycerin), the preparation will normally remain homogeneously mixed without getting a layered appearance. When a preparation of 1:4 (guar gum:glycerin) is made, some of the glycerin will layer and place itself on top of the homogenous mixture in the bottom layer. However, even if this preparation will be easy to dispense and will dissolve easily in the solvent, it contains unnecessary much glycerin.

Two aspects that seem to affect the amount of liquid mixing material that can be used together with a thickening agent without layering during storage are the solubility of the thickening agent in the liquid mixing material and the ability of the thickening agent to swell in the liquid mixing material. Normally, if there is no solubility or ability to swell the only amount of liquid mixing material that can remain homogeneously mixed with the thickening agent is the amount that will fill the gaps between the thickening agent particles. An extra drop of liquid mixing material will result in a layer of liquid mixing material (normally on top). Therefore in order to get enough liquid mixing material homogenously mixed with the thickening agent it is important that the thickening agent has a certain degree of solubility or swelling ability in the liquid mixing material.

The inventors have found that for preparations where a layering occurs during storage, it is in terms of easy dissolution with a solvent normally advantageous to be close to the limit when the preparation starts to layer during storage. Going over the limit for layering is not disadvantageous in terms of easy dissolution in a solvent, but it barely makes the preparation easier to dissolve and therefore the extra amount of liquid mixing material after passing the limit of layering normally is unnecessary. Going in the other direction, by using an amount of liquid mixing material that is much lower than the point for layering, a hard preparation that is difficult to dissolve normally is obtained. Therefore, the solubility or swelling ability of the thickening agent in the liquid mixing material should not be too high, since in that case a high amount of liquid mixing material is needed, in order to not obtain a hard preparation that is difficult to dissolve without formation of lumps, while the preparation becomes voluminous and expensive to manufacture. For example, the thickening agent Guar 5000 cps 200 mesh has a too high solubility and/or swelling ability in a 64% sugar solution (water as solvent) to make the combination suitable for this invention. If a preparation of these components is made in a proportion of 1:3.5 (guar gum:sugar solution) it will directly, following manufacturing, have a suitable, not too high viscosity to meet the requirements of the present invention and it will dissolve easily in water using manual agitation. However, if this preparation is stored for one week it will still remain homogenous, but it will become more viscous, making it more difficult to dispense and it will be very difficult to dissolve it in water without lumping when using manual agitation.

These tests and consideration have lead the inventors to the important conclusion that in order to obtain a preparation containing a combination of a thickening agent and a liquid mixing material that is useful also after storage, it should suitably be able to hold 100% of liquid mixing material in relation in weight to the thickening agent without getting a layered appearance within one week storage. Preferably it should be able to hold more than 140% and even more preferably is if it can hold more than 170% of liquid mixing material without getting a layered appearance within one week storage. However, the preparation should not be able to comprise a too high amount of liquid mixing material without layering, since that means that the thickening agent has a high solubility or swelling ability in the liquid mixing material, which as found above leads to a demand for a high amount of liquid mixing material, which in turn makes the product expensive and voluminous. Accordingly, a preparation of a thickening agent and a liquid mixing material should suitably not be able to hold more than 1500% liquid mixing in weight in relation to the thickening agent without getting a layered appearance within one week. Preferably the preparation should not be able to hold more than 1000% liquid mixing material and more preferably the preparation should not be able to hold more than 750% of liquid mixing material in relation in weight to the thickening agent without getting a layered appearance within one week. It is also important that the preparation does not have a too high viscosity. A high viscosity makes it difficult to dispense the preparation from many packages and a high viscosity often makes it more difficult to dissolve the preparation in the solvent. The viscosity of the preparation is regarding this first embodiment affected by the amount of liquid mixing material, the solubility and/or the ability of the thickening agent to swell in the liquid mixing material and the viscosity of the mixing material.

Examples of suitable thickening agents, their compositions and combinations with liquid mixing materials and suitable viscosity are provided in previous sections. Further, examples of combinations of thickening agents and liquid mixing materials that can create suitable preparations containing an amount of liquid mixing that is enough also after storage to minimize risk for lumping but not creating a too voluminous preparation and not a too viscous preparation are; guar gum and glycerin; tara gum and glycerin; tara gum and propylene glycol; and guar gum and propylene glycol.

For dry, solid preparations the mixing material is a dry element in the form of powder or grains. The powder or grains are mixed with the powder or grains of the thickening agent. If such a preparation is shaken or affected by vibrations during storage or transport the thickening agent and the dry mixing material can more or less separate and lose its homogeneity with the result that the function of the mixing material to minimize lumps following dissolution in the solvent can get lost. The risk for this can be minimized if the mixing material and the thickening agent have a similar particle size and density. Therefore, the present inventors have found a number of suitable relationships between particle densities and sizes for the thickening agent and mixing material, all which are recited in the previous sections. Alternatively, providing preparation as a hard tablet that will fixate the different ingredients so that there can be no separation. The preparation can also be made in the form of agglomerates, as a grain or powder wherein each of the particles contains both the thickening agent and the mixing material. The mentioned dry preparations further can comprise an agent that allows for fast disintegration and dissolution of the powder, tablet or agglomerates. An example of such an agent is an effervescent agent that for example can be made of sodium bicarbonate in combination with citric acid, which often is used in effervescent tablets. Also preparations based on liquid or semisolid mixing materials as mentioned above can benefit from such additives as long as the mixing material or any other ingredient in the preparation does not dissolve or react with the agent. The preparation can also contain other disintegrants that makes the dissolution faster and more efficient (e.g. materials that channel the solvent into the preparation).

In order for a dry mixing material to be able to effectively decrease the risk of lumping when dissolving the preparation, the inventors have found that it is normally important to choose a dry mixing material with a substantially lower increasing effect of the viscosity of the polymer solution (in cold water solution) than the thickening agent. Examples of suitable solid mixing materials, their suitable amounts in preparations and resulting characteristics have been given in previous sections of this specification.

The mixing material can also be in the form of a semisolid material (e.g. paste). Certain semisolid substances can by their rheology fixate the separated thickening agent particles during storage and thereby minimize the risk for lumping when the preparation is mixed with the solvent. Many types of semisolid substances have a suitable rheology. For example the semisolid substance could be a fat, a gel, a paste, an emulsifier, an emulsion or other types of semisolid structures.

In all occasions it is advantageous if the mixing material is soluble in the solvent, or being able to form a homogeneous mixture or emulsion with the solvent by contribution of the thickening agent, or if necessary by the contribution of an additional agent in the preparation. This since it is desirable to obtain a uniform polymer solution without color differences or differences in viscosity.

For conditions, when a low product volume is especially desirable, a liquid or semisolid mixing material is favorable since it creates a product with a high density, compared to using a dry mixing material which normally creates a preparation with a lot of air in the preparation that lowers the density. For products that should be small and easy to carry along, a preparation with a high density is especially advantageous. Further on, for preparations based on liquid or semisolid mixing material it is advantageous if the preparation will sink when it is dispensed into the reservoir of the squirt device (e.g. water gun) filled with water. This since otherwise the preparation will float and might stick to the top or the sides of the reservoir of the squirt device above the water line when the squirt device is shaken to dissolve the preparation, which can increase the risk for lumping. Based on such considerations, a suitable density for a preparation made with a liquid or semisolid mixing material should be higher than 1, preferably it should be higher than 1.075 and more preferably it should be higher than 1.15 (kg/dm³).

The package for the product can be made in many different ways. It is advantageous if the package can be adapted to fit an amount of the preparation to be mixed with a certain amount of solvent. For example a package could be adapted to fit an amount of preparation to be mixed with 1 liter of solvent. The package can also be adapted to the size of the reservoir of a specific squirt device so that it contains enough preparation to make one loaded reservoir of polymer solution. This makes it easier for the user since he/she does not have to measure how much he/she should use of the package. He/she can in that case fill the reservoir of the squirt device with a solvent and empty the whole package.

Since many preparations are quite viscous, it would be difficult and/or time consuming to simply pour the preparation from the package and much of the preparation would remain in the package. Instead, it is advantageous if the preparation can be pressed out from the package. Suitable packages for example, are conventional packages for consumer goods like tubes for tooth pastes, pouches used for dispensing viscous food such as ketchup or other squeezable, compressible or collapsible tubes, bottles, syringes or dispensers, and other packages wherein the storage area in the package gets smaller, whilst the content is being dispensed. Packages that press out the content by pressure, for example from a gas, are also conceivable. Persons skilled in packaging technology are able to find various suitable packages with different solutions to dispense viscous or semisolid compositions in predetermined doses that would be applicable with the present invention.

For viscous preparations that should be pressed out from the package it is advantageous if the opening is smaller than the opening of the reservoir of conventional squirt devices (e.g. water guns). The reason is that the viscous preparation usually gets about the same size as the opening of the package when the content is being pressed out. It should be possible to easily dispense the preparation directly from the package into the reservoir of the squirt device it is important that the string of dispensed preparation is smaller than the opening of the reservoir of the squirt device. However it is also important that the opening is not too small to avoid lumps when dissolving the preparation in water. The reason seems to be that the surface area of a thin string of preparation is much larger compared to a thick string when dispensing a certain amount. A higher surface area seems to increase the risk for lumps, since more of the thickening agent comes in contact with the water before the mixing starts. As mentioned before, with this invention it should be possible to dispense the preparation into the reservoir of a squirt device (e.g. water gun) filled with water, and then shake the squirt device to dissolve the preparation. Since it takes some time from when the first part of the preparation comes in contact with the water until the mixing starts, it is important with a small surface area of the preparation and consequently a not too small opening. Based on these observations, the inventors have found that a suitable area of the opening of the package is between 1-1500 square mm, preferably between 5-700 square mm and more preferably between 10-320 square mm when content is being pressed out.

For highly viscous preparations, or preparations in a dry form (such as in powder, grains, tablets or the like) the package can be in various forms such as bottles, cans, bags, blister pack or other suitable forms to dispense dry matter.

Many suitable preparations can have a tendency to pick up moisture from the air. For such preparations it can be important to have a package with a good water vapor barrier. For bags it can for example be wise to use a plastic laminate containing an aluminum layer to minimize the water pickup.

The package can also be made of a material that dissolves in water. In this case the whole package can be put into the solvent instead of emptying the content of the package into the solvent. Such material can, for example, be made of a biomaterial called Plantic supplied by Plantic Technologies in Australia, which brings advantages for the manufacturer with less wastage of material and for the consumer in terms of easier handling and more precise dosage, compared to an ordinary package wherein some of content may remain in the package.

The preparation can further comprise suitable additives like coloring agents, preservatives, buffering agents, fragrances and flavors. All of these additives are preferably cold water soluble so that they can be dissolved with ordinary tap water. A colored product is especially suitable for visualizing a target hit by the polymer solution and may include fluorescent or phosphorescent agents for use in dim light, black light or darkness. Suitable coloring agents are typically biodegradable, or degradable from environmental influence like light exposure, or unstable in diluted form, or at composition pH, or easily washed away, in order to obtain polymer solutions with colors that disappear or can readily be clean away from targets. Many such suitable coloring agents are well known to skilled artisans and will not be further discussed.

Sodium parabens are suitable preservatives, since they are cold water soluble. Buffering agents can be needed in some applications, for example if a preservative or a color requires a specific pH for its function. Fragrances and flavors can also be added to mask a taste or smell or to improve the taste or smell of the polymer solution.

It is generally important that the ingredients of the preparation are environmentally acceptable, non-toxic and nonirritating (e.g. for the skin) since the product desirably will have its utility outdoors and the produced polymer solution should be harmlessly squirted on persons, or other objects with no protection. In an illustrative example given below all ingredients of the preparation have a low bulk price desirable for consumer goods and are environmentally acceptable, non-toxic, generally accepted as nonirritating and also of food grade, which is advantageous if the polymer solution inadvertently hits the mouth of a person, or is accidentally ingested during games.

In an illustrative example, the product suitable to be mixed with 1 liter of water contains a preparation including:

| | | |
|---|---|---|
| Guar (7000 Cps, 300 mesh) | 9.5 | g |
| Glycerin | 22.5 | g |
| Parabens (preservative) | 2 | g |
| Coloring agents | 0.3 | g |

The exemplified preparation has a viscosity of 267 Pa-s (Measured on an ARES Rheometer from TA Instruments, DE, USA and performed in dynamic mode using a parallel plates with a diameter of 25 mm with 10 rad/s at 25° C., using a strain of 0.3%) which makes it soft enough to be able to easy press it out of a package. The preparation is packaged in a small flat pouch made by a laminate of aluminum and plastic with a size of about 40*120 mm. In a typical mode of operation the product is opened by tearing of the top of the pouch resulting in an opening with a predetermined size of about 75 square mm (when the preparation is being pressed out). The preparation is then pressed out of the package manually into the reservoir of a water gun that is filled to about ⅔ with water. Thereafter, the cap for the reservoir is locked and the water gun is shaken for 45 seconds to dissolve the preparation. The preparation has then transformed the water in the reservoir into a colored polymer solution with a thick slimy consistency. Even though the polymer solution is thick, it is still possible to squirt the slime about the same length or longer than ordinary water since the polymer solution is shear thinning. After it hits a target, the shearing from the squirting stops and the polymer solution gets thick and coherent again and most of the polymer solution stays on the surface without running off. Even though the polymer solution is shear thinning it will under strong shear have a higher viscosity than water alone would have. This result in that the polymer solution leaves the nozzle in a slower speed compared to water. The relatively higher coherency of the polymer solution compared to water however leads to less shattering of the squirt and thereby less friction from the air, resulting in that the polymer solution normally can be squirted longer distances and more accurately towards a target than ordinary water.

The invention as described above will find use both in amusement and games together with a toy water gun, but numerous other commercial applications are conceivable when a squirt device needs to be readily and conveniently loaded with a polymer solution. For example, the present invention may found use in ambulatory conditions in for example agriculture or foresting, where there may be need to quickly, provisionally and without any harm mark selected examined objects with differently colored polymer solutions for subsequent identification.

1. A method of providing a storage stable product suitable for ambulatory forming a squirtable polymer solution that can be used in squirt devices following mixture with an operating solvent, characterized by the steps of:
(i) selecting a polymer thickening agent capable of providing squirtable viscous polymer solutions, selecting mixing material that is liquid; and providing preparations of thickening agent and mixing material with different weight ratios of thickening agent and mixing material;
(ii) selecting the preparations of step (i) which retain a homogenous appearance after at least 1 hour, preferably at least 1 day and more preferably at least 1 week storage; and
(iii) selecting preparations obtained in step (ii) which are easily dissolved in water with manual agitation and selecting such preparations for manufacturing a storage stable product.

2. A method of providing a storage stable product suitable for ambulatory forming a squirtable polymer solution that can be used in squirt devices following mixture with an operating solvent characterized by the steps of:
(i) selecting a polymer thickening agent capable of providing squirtable viscous polymer solutions, selecting a mixing material that is liquid; and providing preparations of thickening agent and mixing material with different weight ratios of thickening agent and mixing material;
(ii) selecting preparations provided in step (i) that easily can be dissolved in water with manual agitation to a squirtable polymer solution without formation of lumps;
(iii) selecting the preparations obtained from step (ii) which retain a homogenous appearance after at least 1 hour, preferably at least 1 day and more preferably at least 1 week storage; and
(iv) verifying if the preparations obtained in step (iii) are easily dissolved in water using manual agitation and selecting such preparations for manufacturing a storage stable product.

3. A method according to claim 1 or 2, wherein a water solution containing 2% (weight) of a preparation obtained according to claim 1 or 2 has a viscosity of at least 1000 Cps after 24 hours (Brookfield RTV Viscometer, 25° C., Spindle No. 3 or 4, 20 rpm).

4. A method according to any of the preceding claims, characterized by providing preparations of thickening agent:mixing material in step (i) in a weight ratio range from 1:1 to 1:15, whereby a preparation retains a homogenous appearance at a proportion of 1:1, but gets a layered appearance at a proportion of 1:15 following storage during 1 week.

5. A method according to any of the preceding claims, characterized by providing preparations of thickening agent:mixing material in step (i) in a weight ratio range from 1:1.4 to 1:10, whereby a preparation retains a homogenous appearance at a proportion of 1:1.4, but gets a layered appearance at a proportion of 1:10 following storage during 1 week.

6. A method according to any of the preceding claims, characterized by providing preparations of thickening agent:mixing material in step (i) in a weight ratio range from 1:1.7 to 1:7.5, whereby a preparation retains a homogenous appearance at a proportion of 1:1.7, but gets a layered appearance at a proportion of 1:7.5 following storage during 1 week.

7. A product provided by the method according to any of claim 1 to 6.

8. A product comprising a preparation for mixture with a solvent to form a squirtable polymer solution for use in squirt devices characterized in that the preparation comprises a polymer thickening agent in combination with a mixing material, wherein the mixing material is selected and formulated so that the preparation after at least 1 week storage has a lower tendency for lumping when dissolved in a solvent using manual agitation, compared to using the same manual agitation to dissolve in the same solvent a preparation without said mixing material, but comprising the same amount of thickening agent.

9. A product according to any of claims 7 to 8, wherein the solvent is water and the thickening agent and the mixing material are selected and formulated so that the preparation retains a homogenous appearance during storage of at least 1 week.

10. A product according to any of claims 7 to 9, wherein the mixing material is soluble in the solvent or capable of forming a homogenous mixture or emulsion with the solvent by contribution of the thickening agent, or if necessary by the contribution of an additional agent in the preparation.

11. A product according to any of claims 7 to 10, wherein the mixing material is a liquid.

12. A product according to claim 11, wherein the preparation of thickening agent and mixing material retains a homogeneous appearance after 1 week storage, when prepared in a weight ratio of thickening agent:mixing material of 1:1, but that gets a layered appearance after 1 week storage when prepared at a weight ratio of 1:15.

13. A product according to claim 11, wherein the preparation of thickening agent and mixing material retains a homogeneous appearance after 1 week storage, when prepared in a weight ratio of thickening agent:mixing material of 1:1.4, but that gets a layered appearance after 1 week storage when prepared at a weight ratio of 1:10.

14. A product according to claim 11, wherein the preparation of thickening agent and mixing material retains a homogeneous appearance after 1 week storage, when prepared in a weight ratio of thickening agent:mixing material of 1:1.7, but that gets a layered appearance after 1 week storage when prepared at a weight ratio of 1:7.5.

15. A product according any of claims 7 to 10, wherein the mixing material is semisolid.

16. A product according to any of claims 7 to 15, wherein the mixing material is a liquid or a semisolid material that provides a preparation with a density above 1, preferably above 1.075 and more preferably above 1.15 (kg/dm³).

17. A product according to any of claims 7 to 16, wherein the weight ratio of thickening agent:mixing material is within the range of 1:1 to 1:15, preferably in the range of 1:1.4 to 1:10, and more preferably in the range of 1:1.7 to 1:7.5.

18. A product according to any of the preceding claims reciting a liquid mixing material, wherein the mixing material is glycerin or propylene glycol.

19. A product according to any of claims 11 to 18, wherein the preparation has a viscosity that is less than 500000 Pa-s, preferably less than 50000 Pa-s, and more preferably less than 5000 Pa-s (at 25 degrees C. and 10 rad/s).

20. A product according to any of claims 7 to 10, wherein the mixing material is a powder or grains.

21. A product according to claim 18, wherein the mixing material is cold water soluble.

22. A product according to claim 20 or 21, wherein the material with the highest particle density of the mixing material and the thickening agent do not deviate in particle density more than 500%, preferably not more than 100% and more preferably not more than 50%, from the material with the lower particle density of the mixing material and the thickening agent.

23. A product according to any of claims 20 to 22, wherein the difference in average particle size in microns between the thickening agent and the mixing material is less than 50000%, preferably 7500%, and more preferably less than 500% (as measured with e.g. Tyler Standard Screen Scale Sieve Series).

24. A product according to claim 20 to 23, wherein the powder or grains of the mixing material has been pressed together with the thickening agent to form a tablet.

25. A product according to claim 20 to 23, wherein the thickening agent and mixing material has been mixed and agglomerated into a powder or grain for the purpose of making each particle contain both mixing material and thickening agent.

26. A product according to any of the preceding claims, wherein the preparation comprises one or several effervescent agent(s) that allows for disintegration of the preparation when it is put into the solvent.

27. A product according to any of claims 20 to 26, wherein a water solution of the mixing material has a viscosity (at 25 degrees C.) that is less than 30%, preferably less than 10%, more preferably less than 5% of the viscosity of a water solution with same amount (weight) of thickening agent.

28. A product according to any of claims 20 to 27, wherein the mixing material is selected from the group consisting of sugars, sugar alcohols, oligosaccharides, polysaccharides and any mixture thereof.

29. A product according to any of claims 20 to 28, wherein the weight of the mixing material is at least 10%, preferably at least 80%, and more preferably at least 150% of the weight of the thickening agent.

30. A product according to claims 20 to 29, wherein the dry thickening agent has a particle size, corresponding to a mesh number of 50, or higher, preferably, a mesh number of 100, or higher, or more preferably a mesh number of 150, or higher (as measured with e.g. Tyler Standard Screen Scale Sieve Series).

31. A product according to any of claims 7 to 30, wherein the thickening agent is cold water soluble.

32. A product according to any of claims 7 to 31, wherein the thickening agent is capable of forming a shear thinning solution after being mixed with the solvent.

33. A product according to any of claim 7 to 32, wherein the thickening agent is selected from the group consisting of guar gum, tara gum, carrageenan, carboxymethylcellulose (CMC), xanthan gum, alginate, dextran, hydroxyethylcellulose (HEC) and hydroxypropylcellulose, or mixtures thereof.

34. A product according to claim 33, wherein the thickening agent is tara gum or guar gum.

35. A product according to any of claims 7 to 34, wherein a 1% (weight) water solution of thickening agent has a viscosity of at least 500 Cps, preferably at least 1 000 Cps, more preferably at least 2000 Cps after 24 hours (Brookfield RVT Viscometer 25° C., Spindle No. 3 or 4, 20 rpm).

36. A product according to any of claims 7 to 35 comprising thickening agent in an amount of 0.05-15%, preferably 0.15-8%, more preferably 0.3-3%, in relation to the weight of the solvent to be mixed with.

37. A product according to any of claims 7 to 36, wherein the preparation has a weight that is less than 15%, preferably less than 12%, more preferably less than 7.5% of the weight of the solvent to be mixed with.

38. A product, according to claim 18, 19 or 37, wherein the preparation comprises guar as a thickening agent, glycerin as a mixing material, which when dissolved with water to a 1% (weight) solution of guar has a viscosity of at least 2500 Cps after 24 hours (Brookfield RVT Viscometer 25° C., Spindle No. 3 or 4, 20 rpm).

39. A product according to any of claims 7 to 38, further comprising a storage package capable of accommodating the preparation.

40. A product according to claim 39, wherein the package is adapted so that the preparation is squeezed or pressed out when emptying said package.

41. A product according to claim 39 or 40, wherein the package at least partially is made from a material that is soluble in said solvent.

42. A product according to any of claims 39 to 41, having an opening which when the preparation is squeezed or pressed out of the package is between 1-1500 square mm, preferably between 5-700 square mm and more preferably between 10-320 square mm.

43. A product according to any of the preceding claims, wherein the preparation comprises a color, a preservative, a buffering agent, a flavor or a fragrance, or a combination of these.

44. A kit comprising at least one product according to any of claims 7 to 43 and at least one squirt device.

45. A method of loading a squirt device with a squirtable polymer solution preparation including the steps of:
(a) employing a product according to any of claims 7 to 43.
(b) admixing said product with a solvent into the final squirtable solution.

46. A method according to claim 45, characterized by dispensing the preparation from a package according to any of claims 39 to 43.

47. A method according to claim 45 or 46 characterized by dispensing the preparation and dispensing the solvent into the reservoir of a squirt device.

48. A method according to any of claims 45 to 47, wherein the admixing is made by manually shaking the reservoir of the squirt device.
